(19) United States
(12) Patent Application Publication
(10) Pub. No.: US 2022/0156440 A1
(43) Pub. Date: May 19, 2022

(54) COMPOSITE MATERIAL DESIGN DEVICE, COMPOSITE MATERIAL DESIGN METHOD, AND COMPOSITE MATERIAL DESIGN PROGRAM USING GENETIC ALGORITHM

(71) Applicant: MITSUBISHI HEAVY INDUSTRIES, LTD., Tokyo (JP)

(72) Inventors: Tetsuyuki MASUKO, Tokyo (JP); Tomohiro MIZUNO, Tokyo (JP)

(21) Appl. No.: 17/440,900

(22) PCT Filed: Mar. 18, 2020
(86) PCT No.: PCT/JP2020/012084

§ 371 Date: Sep. 20, 2021

(30) Foreign Application Priority Data
Apr. 15, 2019 (JP) 2019-076975

(51) Int. Cl. G06F 30/27; B29C 70/54

(52) U.S. Cl. CPC G06F 30/27; B33Y 30/00; B29C 70/54

(57) ABSTRACT

A composite material design device using a genetic algorithm includes: a first generation generating unit that generates, as a first-generation group of individuals, a plurality of individual models using each of laminate member models having strength directionalities designed on the basis of a load condition; an evaluating unit that segments each individual model in the generated group of individuals into predetermined cells, and evaluates a lamination pattern in each cell using at least one of indices including symmetry, adjacent directionality, and continuous laminability; and a next generation generating unit that selects an individual model from the group of individuals through ranked selection, generates a new individual model through crossover, replication, and mutation, and updates the group of individuals as a next generation.

### TECHNICAL FIELD

The present invention relates to a composite material design device, a composite material design method, and a composite material design program using a genetic algorithm.

### BACKGROUND ART

A composite material such as CFRP or GFRP is manufactured by laminating a unidirectional material or a woven material such as a prepreg (for example, PTL 1). As a material to be laminated, there are a material which is impregnated with a resin in advance, a material with only a fiber which is not impregnated with the resin, and the like.

### CITATION LIST

### Patent Literature

[PTL 1] U.S. Pat. No. 6,555,488

### SUMMARY OF INVENTION

### Technical Problem

Depending on an order of lamination of each lamination member in a composite material, defects may occur in the completed composite material. For example, cracks and warpage may occur depending on the order. Accordingly, it is necessary that the lamination order of the composite material is designed by a skilled designer, which imposes a heavy burden in human resource.

PTL 1 suggests that a genetic algorithm is used for optimizing formation of a composite material, but it does not disclose a specific processing content using the genetic algorithm.

The present invention has been made in view of such circumstances, and a subject thereof is to provide a composite material design device, a composite material design method, and a composite material design program using a genetic algorithm capable of automatically designing a more appropriate lamination order.

### Solution to Problem

According to a first aspect of the present invention, there is provided a composite material design device using a genetic algorithm, the device including: an initial generation generating unit that generates, as an initial generation group of individuals, a plurality of individual models by laminating each lamination member model having a directionality of strength designed based on a load condition in plurality of orders, an evaluation unit that divides each individual model in the generated group of individuals into predetermined cells, and evaluates a lamination pattern of each cell by using at least any one index of a symmetry regarding the lamination of the lamination member models, a directionality of adjacent lamination member models, and continuous lamination properties of the lamination member models having the same directionality, a ranking unit that ranks each individual model of the group of individuals based on the evaluation of the evaluation unit, a next generation generating unit that selects an individual model having a high evaluation value from the group of individuals based on the ranking, generates a new individual model by selecting at least any one of crossover, replication, and mutation, and updates the group of individuals as a next generation, and an identification unit that identifies the individual model having the high evaluation value based on the ranking.

According to the configuration, the individual model in which the lamination member models are laminated is divided into predetermined cells, and the lamination pattern of each cell is evaluated by using at least any one index of a symmetry regarding the lamination of the lamination member models, a directionality of the adjacent lamination member models, and continuous lamination properties of the lamination member models having the same directionality, and accordingly, the evaluation can be performed for each cell. For each cell, it is possible to evaluate whether or not the symmetry regarding the lamination of the lamination member model, the directionality of the adjacent lamination member models, and the continuous lamination properties of the lamination member models having the same directionality are preferable, and thus the individual model can be evaluated in detail. Since the symmetry regarding the lamination of the lamination member model is used as the index of the evaluation, it is possible to evaluate whether or not warpage is likely to occur in an actual manufacturing process. Since the directionality of the adjacent lamination member models is used as the index of the evaluation, it is possible to evaluate whether or not peeling is likely to occur at an interface. Since the continuous lamination properties of the lamination member models having the same directionality are used as the index of the evaluation, it is possible to evaluate whether or not cracks are likely to occur. The directionality of strength is, for example, an extending direction of fibers of a fiber reinforced plastic in the lamination member.

In addition, since the ranking is performed based on the evaluation and the individual model having a high evaluation value is selected based on the ranking, it is possible to generate a new individual model using an individual model more matching to the index of the evaluation (generate a next generation group of individuals), and proceed progress so as to more match to the index of the evaluation.

Since the individual model is identified based on the ranking, it is possible to identify a more optimal lamination pattern of the lamination members.

That is, it is possible to automatically identify a more appropriate lamination pattern of the lamination members based on the index, reduce the burden of human resource, and design a composite material with an appropriate lamination pattern of the lamination member.

In the composite material design device, the evaluation unit may evaluate each cell in the individual model using the index, and integrate the evaluation of each cell in the individual model to perform evaluation of the individual models.

According to the configuration described above, since each cell is evaluated, and the evaluation of each cell is integrated to perform the evaluation of the individual model, it is possible to evaluate each part in detail and perform the evaluation of all of individual models.

In the composite material design device, in a case of evaluating the lamination pattern of the cell using a plurality of types of the indices, the evaluation unit may evaluate the cell according to an evaluation norm based on each index.

According to the configuration described above, in a case of using the plurality of types of indices in the evaluation, the evaluation norm based on each index is obtained, and accordingly, the evaluation of each index can be balanced. That is, it is possible to suppress that only a specific index has a strong influence on the evaluation, and to determine the evaluation of each index in a well-balanced manner as a whole.

In the composite material design device, the crossover may be a sequential crossover or a partial mapping crossover.

According to the configuration described above, by using the sequential crossover or the partial mapping crossover, it is possible to perform the crossover without affecting a configuration of each lamination member model having directionality designed based on the load condition (configuration regarding the number of lamination members having a certain directionality included) at the time of creating the initial generation. Therefore, it is possible to design the lamination pattern of the lamination member models so as to more reliably satisfy the load condition.

In the composite material design device, the mutation may occur by selecting a section having a predetermined width in a lamination direction in a laminated state of the lamination member model in the selected individual model, and rearranging a lamination order of the lamination member models in the section.

According to the configuration described above, since the mutation may occur by rearranging the lamination order in the selected section having the predetermined width in the lamination direction in the laminated state of the lamination member model in the individual model, it is possible to occur mutation without affecting the configuration of each lamination member model having a directionality designed based on load condition (configuration regarding the number of lamination members having a certain directionality included) at the time of creating the initial generation. Therefore, it is possible to design the lamination pattern of the lamination member models so as to more reliably satisfy the load condition.

In the composite material design device, the predetermined width may be preset in a range of ¼ or less with respect to a total number of laminated layers of the lamination member models in the individual models.

According to the configuration described above, since the predetermined width is set in a range of ¼ or less with respect to the total number of laminated layers of the lamination member models in the individual models, it is possible to suppress a significant change of the lamination order of the individual models that cause mutation and cause the mutation so that the evaluation becomes higher.

In the composite material design device, the next generation generating unit may select at least any one processing of the crossover, the replication, and the mutation based on a preset probability of occurrence for each process, and increase the probability of occurrence regarding the mutation, in a case of creating the group of individuals for a predetermined generation.

According to the configuration described above, in a case of creating the group of individuals for the predetermined generation, by increasing the probability of occurrence of mutation, the mutation is likely to occur and it is possible to suppress maintenance of the local optimum solution.

In the composite material design device, the evaluation unit may perform evaluation based on the index and the directionality of the lamination member model laminated on an outermost side.

According to the configuration described above, since the progress can proceed by including the directionality of the lamination member model laminated on the outermost side in the evaluation, it is possible to control so that the directionality of the lamination member model laminated on the outermost side is, for example, a predetermined directionality.

According to a second aspect of the present invention, there is provided a composite material design method using a genetic algorithm, the method including: an initial generation generating step of generating, as an initial generation group of individuals, a plurality of individual models by laminating each lamination member model having a directionality of strength designed based on a load condition in plurality of orders, an evaluation step of dividing each individual model in the generated group of individuals into predetermined cells, and evaluating a lamination pattern of each cell by using at least any one index of a symmetry regarding the lamination of the lamination member models, a directionality of adjacent lamination member models, and continuous lamination properties of the lamination member models having the same directionality, a ranking step of ranking each individual model of the group of individuals based on the evaluation of the evaluation step, a next generation generating step of selecting an individual model having a high evaluation value from the group of individuals based on the ranking, generating a new individual model by selecting at least any one of crossover, replication, and mutation, and updating the group of individuals as a next generation, and an identification step of identifying the individual model having the high evaluation value based on the ranking.

According to a third aspect of the present invention, there is provided a composite material design program using a genetic algorithm for causing a computer to execute: an initial generation generating process of generating, as an initial generation group of individuals, a plurality of individual models by laminating each lamination member model having a directionality of strength designed based on a load condition in plurality of orders, an evaluation process of dividing each individual model in the generated group of individuals into predetermined cells, and evaluating a lamination pattern of each cell by using at least any one index of a symmetry regarding the lamination of the lamination member models, a directionality of adjacent lamination member models, and continuous lamination properties of the lamination member models having the same directionality, a ranking process of ranking each individual model of the group of individuals based on the evaluation of the evaluation process, a next generation generating process of selecting an individual model having a high evaluation value from the group of individuals based on the ranking, generating a new individual model by selecting at least any one of crossover, replication, and mutation, and updating the group of individuals as a next generation, and an identification process of identifying the individual model having the high evaluation value based on the ranking.

### Advantageous Effects of Invention

According to the present invention, an effect that a more appropriate lamination order can be automatically designed is exhibited.

### BRIEF DESCRIPTION OF DRAWINGS

FIG. 1 is a functional block diagram showing a function provided by a composite material design device according to an embodiment of the present invention.

FIG. 2 is a diagram showing a laminated structure of 45° layers when a composite material is seen from the lamination direction in the composite material design device according to the embodiment of the present invention.

FIG. 3 is a diagram showing a laminated structure of 0° layers when a composite material is seen from the lamination direction in the composite material design device according to the embodiment of the present invention.

FIG. 4 is a diagram in which the laminated structure of the 45° layer is divided into each lamination member in the composite material design device according to the embodiment of the present invention.

FIG. 5 is a diagram in which the laminated structure of the 0° layer is divided into each lamination member in the composite material design device according to the embodiment of the present invention.

FIG. 6 is a diagram showing an example of an individual model generated in the composite material design device according to the embodiment of the present invention.

FIG. 7 is a diagram showing an example in which cells are set in the individual model in the composite material design device according to the embodiment of the present invention.

FIG. 8 is a diagram showing an example of a selection probability in the composite material design device according to the embodiment of the present invention.

FIG. 9 is a diagram showing an example of a sequential crossover in the composite material design device according to the embodiment of the present invention.

FIG. 10 is a diagram showing an example of a partial mapping crossover in the composite material design device according to the embodiment of the present invention.

FIG. 11 is a diagram showing an example of mutation in the composite material design device according to the embodiment of the present invention.

FIG. 12 is a diagram showing a flowchart of a lamination order optimization process of the composite material design device according to the embodiment of the present invention.

FIG. 13 is a diagram showing a case of multi-purpose optimization of the composite material design device according to the embodiment of the present invention.

### DESCRIPTION OF EMBODIMENTS

Hereinafter, an embodiment of a composite material design device, a composite material design method, and a composite material design program using a genetic algorithm according to the present invention will be described with reference to the drawings. The composite material is used in various structures such as panels for main wings, fuselage, and tail wings of airplanes.

The composite material is CFRP or GFRP manufactured by laminating a unidirectional material or a woven material represented by a prepreg. The composite material is configured by laminating the lamination members (plies) having a directionality of strength in combination so as to satisfy the load condition applied in a predetermined direction. The lamination member having a directionality of strength is a lamination member with strength improved in the direction. The directionality of strength is, for example, an extending direction of fibers of fiber reinforced plastic. As described above, by laminating the lamination member having great strength in a specific direction, the composite material is configured to satisfy a predetermined load condition.

A composite material design device 1 identifies more optimal lamination order of the lamination members by using a genetic algorithm. That is, the composite material design device 1 simulates the optimal lamination order of the lamination members in a stage before manufacturing the composite material. Accordingly, the composite material design device 1 performs simulation by the genetic algorithm by using an individual model generated by laminating models (hereinafter, referred to as “lamination member models”) corresponding to actual lamination members (hereinafter, referred to as an “individual model”). The lamination member model may include information on a shape and directionality of the lamination member.

The composite material design device 1 is configured with, for example, a central processing unit (CPU) (not shown), a memory such as a random access memory (RAM), a computer-readable recording medium, and the like. A series of processing processes for realizing various functions which will be described later is recorded on a recording medium or the like in a form of a program, and this program is read out by the CPU on the RAM or the like to execute processing and operation processes of the information, thereby realizing various functions which will be described later. The program may be installed in a ROM or other storage medium in advance, may be provided in a state of being stored in a computer-readable storage medium, or may be distributed via a wired or wireless communication means. The computer-readable storage medium includes a magnetic disk, a magneto-optical disk, a CD-ROM, a DVD-ROM, a semiconductor memory, and the like.

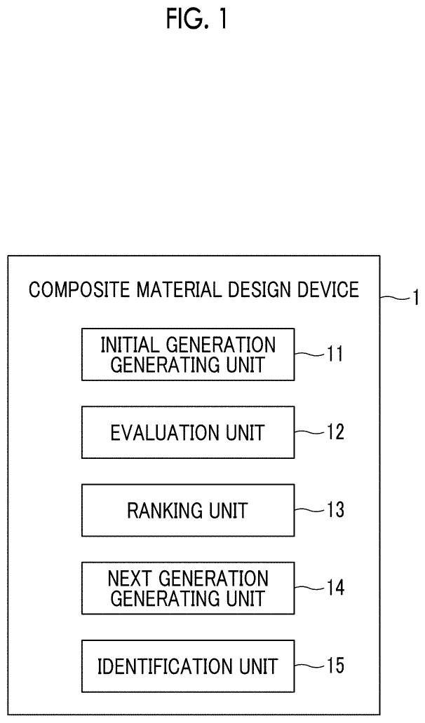

FIG. 1 is a functional block diagram showing a function provided by the composite material design device 1. As shown in FIG. 1, the composite material design device 1 includes an initial generation generating unit 11, an evaluation unit 12, a ranking unit 13, a next generation generating unit 14, and an identification unit 15.

The initial generation generating unit 11 generates an initial generation group of individuals, in order to apply a genetic algorithm. Specifically, the initial generation generating unit 11 generates a plurality of individual models by laminating each lamination member model having a directionality of strength designed based on the load condition in a plurality of orders, and generates an initial generation group of individuals.

First, the initial generation generating unit 11 sets a laminated structure of each constituent member to be laminated in the composite material so as to match to the load condition. The load condition is a required load performance preset based on a load estimated in an environment in which the composite material is used, and includes a load state and a load direction. The laminated structure is information related to the configuration of the lamination member included in the composite material in order to match to the load condition, and is a type of the lamination member included. In the laminated structure, the directionality of the lamination members, the number of lamination members in the directionality, and the shape of each lamination member are set so as to satisfy the load condition. The laminated structure includes the structure of the lamination members to be laminated, but does not include the lamination order. That is, if each lamination member set to match to the load condition is included, it is possible to match to the load condition, and a genetic algorithm which will be described later is applied to optimize the lamination order.

As described above, the configuration of the lamination member (laminated structure) is set so as to withstand the direction and magnitude of the load indicated by the load condition in the environment in which the composite material is actually used. In the initial generation generating unit 11, in order to perform a virtual simulation, each lamination member having a laminated structure set to satisfy the load condition is used as a lamination member model, and an individual created by laminating the lamination member models is set as an individual model. Since the lamination member having directionality forms a layer, the layer corresponding to each directionality (angle) is referred to as an angle layer. For example, a layer having a directionality of 45° is referred to as a 45° layer.

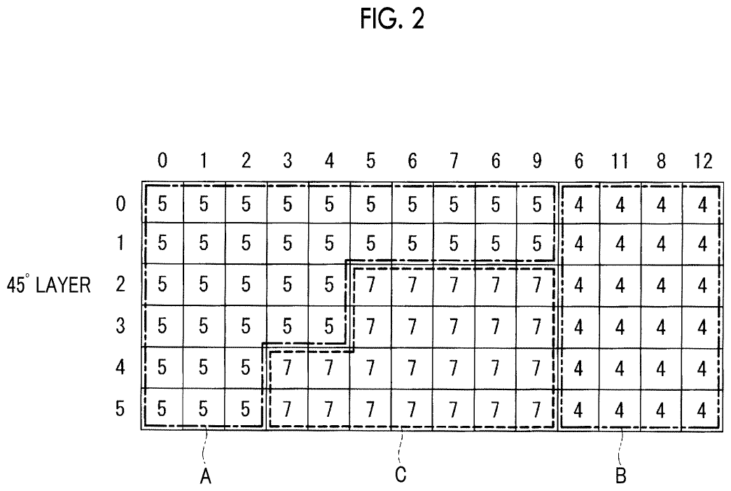

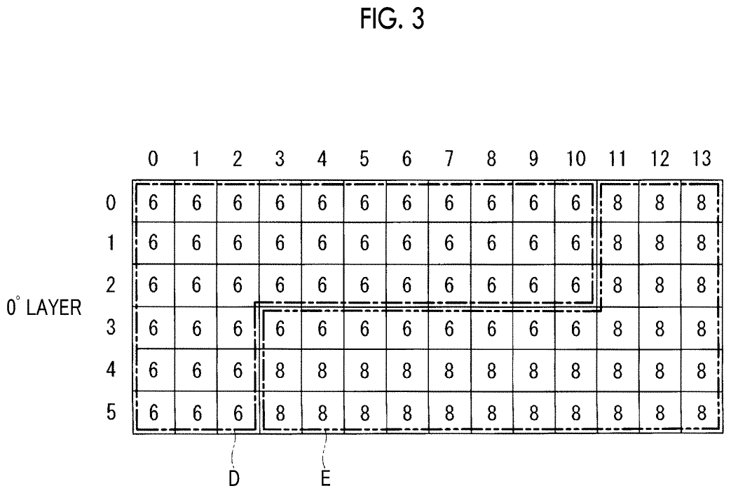

FIGS. 2 and 3 are diagrams showing the laminated structure of each angle layer, when the composite material is seen from the lamination direction. The laminated structure of FIGS. 2 and 3 is set based on a predetermined load condition. FIG. 2 shows a laminated structure of lamination members having a directionality of 45°, and FIG. 3 shows a laminated structure of lamination members having a directionality of 0°. That is, in order to satisfy the load condition, the composite material includes a 45° layer as shown in FIG. 2 and a 0° layer as shown in FIG. 3, when seen from the lamination direction. In the present embodiment, it is described that the composite material is configured with the lamination members having directionalities of 45° and 0° as shown in FIGS. 2 and 3, but the load condition may be set to include a lamination member having other directionality of 90° and the like.

In FIGS. 2 and 3, in directions of orthogonal axes (horizontal axis and vertical axis) of a two-dimensional plane, when seen from the lamination direction, cells are defined for positions of the respective axes. Specifically, the cells are divided into 13 cells in the horizontal axis direction (0 to 12 on the horizontal axis) and 6 cells in the vertical axis direction (0 to 5 on the vertical axis). The number in each cell indicates the number of lamination members having the corresponding directionality. Specifically, as shown in FIG. 2, five lamination members having a directionality of 45° are laminated in the lamination direction in a region A, four lamination members having a directionality of 45° are laminated in the lamination direction in a region B, and seven lamination members having a directionality of 45° are laminated in the lamination direction in a region C. As shown in FIG. 3, six lamination members having a directionality of 0° are laminated in the lamination direction in a region D, and eight lamination members having a directionality of 0° are laminated in the lamination direction in a region E. The directionality (angle), the shape, and the number of lamination members of each laminated structure as shown in FIGS. 2 and 3 are set based on the load conditions.

When the laminated structure of each angle layer is determined based on the load condition, the initial generation generating unit 11 divides the laminated structure of each angle layer into lamination members to be laminated.

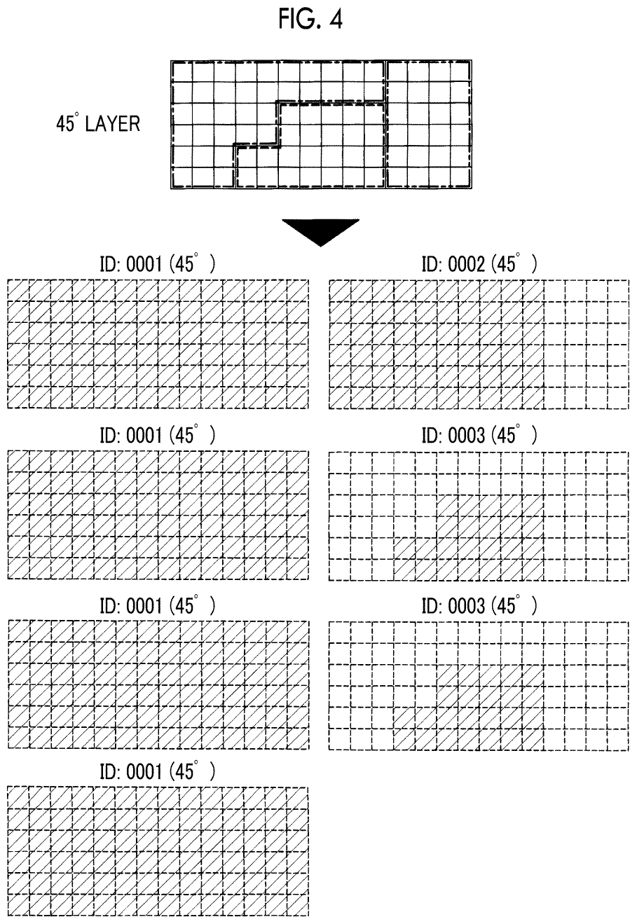

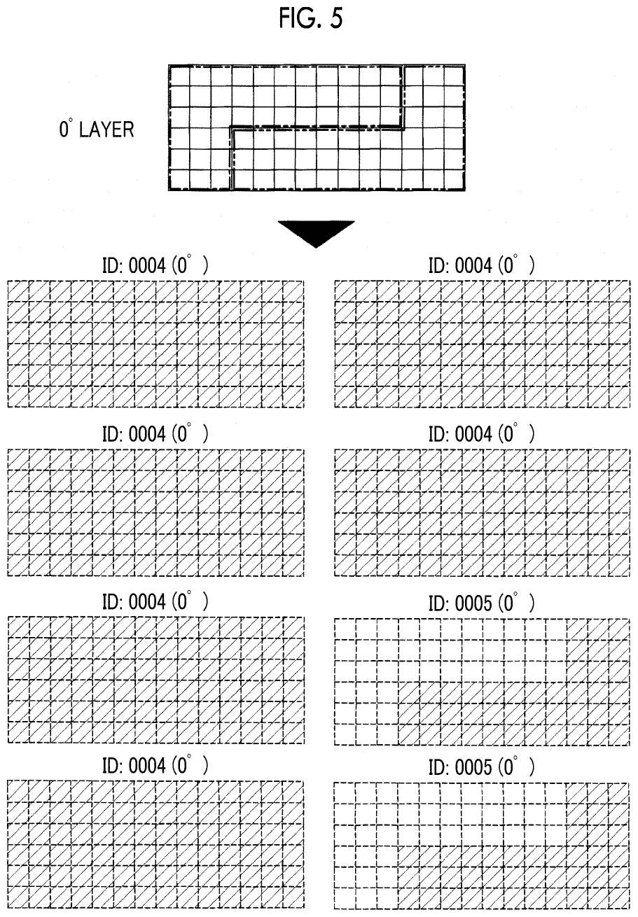

Specifically, the initial generation generating unit 11 divides the laminated structure of each angle layer as shown in FIGS. 2 and 3 into each lamination member as shown in FIGS. 4 and 5. That is, the laminated structure is divided for each lamination member. FIG. 4 is a diagram in which the laminated structure of the 45° layer of FIG. 2 is divided into lamination members, and FIG. 5 is a diagram in which the laminated structure of the 0° layer of FIG. 3 is divided into lamination members. In FIGS. 4 and 5, each lamination member is shown with the cells of FIGS. 2 and 3 as the background, and shaded portions are the lamination members. That is, in FIG. 4, in a case where the divided lamination members are laminated according to the positions of the cells, the laminated structure of the 45° layer shown in FIG. 2 is obtained. In FIG. 5, in a case where the divided lamination members are laminated according to the positions of the cells, the laminated structure of the 0° layer shown in FIG. 3 is obtained. That is, since the lamination members having the laminated structure of each angle layer of FIGS. 4 and 5 are laminated in a mixed manner, it is possible to configure the composite material matching to the load condition.

Unique identification information is given to each of the divided lamination members. By attaching the same identification information (hereinafter, referred to as “ID”) to the lamination members having the same directionality and the same shape, it is possible to reduce a processing load. In the example of FIG. 4, IDs of 0001 (45°), 0002 (45°), and 0003(45°) are applied according to the shape. In the example of FIG. 5, 0004 (0°) and 0005 (0°) are applied according to the shape. Each lamination member divided as described above is used as the lamination member model in order to perform a virtual simulation.

In the composite material, it is possible to match to the load condition, as long as all the divided lamination members are included. However, warpage or the like may occur depending on the lamination order of the lamination members. Therefore, the lamination order (stacking sequence) of the lamination members is optimized by using the genetic algorithm.

The initial generation generating unit 11 creates a predetermined number of (e.g., 100) individual models by randomly set the lamination order of the divided lamination member models. In the present embodiment, each individual model is described by showing an example in which the lamination member models are laminated in different lamination orders, but the present invention is not limited to this example. For example, the individual models may be laminated by fixing each lamination member model of a specific angle layer at a specific position. In each individual model, in order to satisfy each load condition, all of the divided lamination member models are laminated. That is, the configurations of the lamination member models that are laminated are the same, and a plurality of individuals having different lamination orders are generated. The individuals generated as described above are set as the initial generation group of individuals.

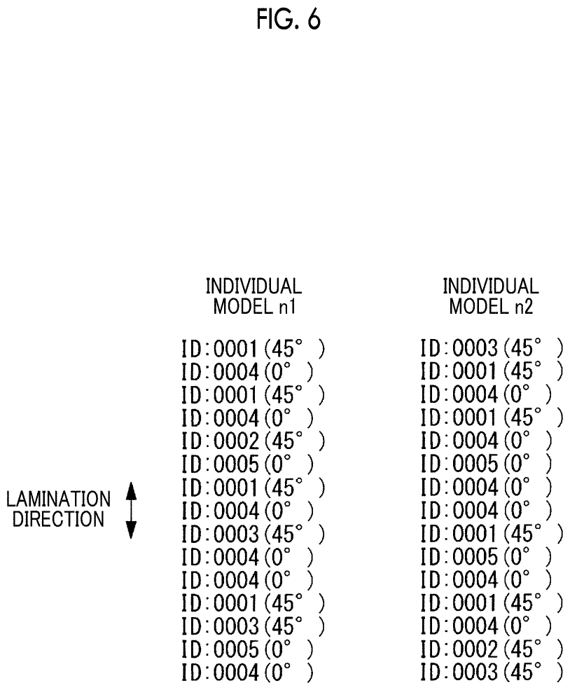

Specifically, when the laminated structure of each angle layer is divided into each lamination member model as shown in FIGS. 4 and 5, the initial generation generating unit 11 randomly determines the lamination orders and generates a predetermined number of individual models by using all of the divided lamination member models. The lamination order can be expressed using the ID attached to each lamination member model. FIG. 6 is an example of an initial generation individual model (individual model n1 and individual model n2) corresponding to the examples of FIGS. 4 and 5. Each individual model includes each lamination member model divided as shown in FIGS. 4 and 5, and the lamination orders are different. As in the example of FIG. 6, a predetermined number (for example, 100) of individual models having different lamination orders are generated, and the initial generation group of individuals is obtained.

The information on the initial generation group of individuals generated as described above is output to the evaluation unit 12.

The evaluation unit 12 divides each individual model of the generated group of individuals into predetermined cells, and evaluates the lamination pattern of each cell by using at least any one index of a symmetry regarding the lamination of the lamination member models (hereinafter, simply referred to as a “symmetry”), a directionality of adjacent lamination member models (hereinafter, simply referred to as an “adjacent directionality”), and continuous lamination properties of the lamination member models having the same directionality (hereinafter, simply referred to as “continuous lamination properties”). The evaluation unit 12 evaluates each cell in the individual model using the index, integrates the evaluation of each cell of the individual model, and evaluates the individual model. In the present embodiment, the case where the evaluation is performed using the three indices of the symmetry, the adjacent directionality, and the continuous lamination properties is described, but at least one of them may be used.

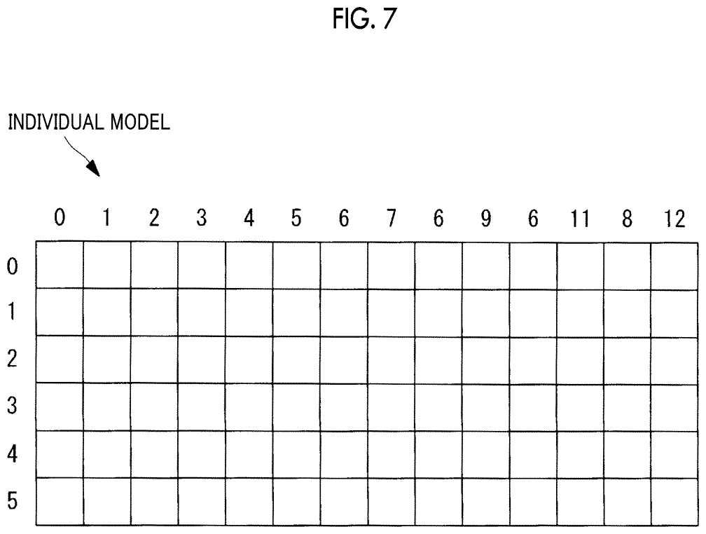

First, the evaluation unit 12 divides the individual model into predetermined cells in order to evaluate each individual model. The cells are set to be divided into small regions, when the individual model is seen in the lamination direction. As shown in FIG. 7, for example, the cell is defined for the position of each axis in an orthogonal axis (horizontal axis and vertical axis) direction of the two-dimensional plane when the individual model is seen in the lamination direction. Each cell in FIG. 7 is the same as the cell in FIGS. 2 and 3.

Specifically, by dividing the cells into 13 cells in the horizontal axis direction (0 to 12 on the horizontal axis) and 6 cells in the vertical axis direction (0 to 5 on the vertical axis), the cells are divided into 78 cells when seen the individual model in the lamination direction, and each cell is evaluated. Each cell is evaluated with the predetermined indices (symmetry, adjacent directionality, continuous lamination properties) with respect to the state in the lamination direction (lamination pattern) of each cell.

By evaluating each of the divided cells, it is possible to evaluate the individual model in detail. For evaluation, a penalty score is applied based on each index. That is, in each index, a higher score is applied for a state that is not preferable. Specifically, the worse the symmetry, the higher the score, the worse the adjacent directionality, the higher the score, and the worse the continuous lamination properties, the higher the score. By applying the penalty score, it is possible to identify an individual model which is not preferred more. The evaluation is not limited to the penalty score, and a higher score may be applied, as the state is preferable in each index.

The symmetry (symmetry regarding the lamination of the lamination member models) is a symmetric state of the laminated state of each lamination member model in the lamination direction. For example, if a specific angle layer is biasedly laminated on one side with respect to a midpoint in the lamination direction and another angle layer is biasedly laminated to another side, the symmetry is poor. If the symmetry is poor, warpage is likely to occur in the actual manufacturing process. Accordingly, by performing the evaluation by using the symmetry as an index, it is possible to evaluate whether or not the warpage is likely to occur in the actual manufacturing process. When performing the evaluation using the symmetry, a higher score (penalty score) is applied, as the symmetry becomes poor (as the lamination pattern of the lamination member model becomes unbalanced), based on the symmetry of the laminated state in the lamination direction.

The adjacent directionality (directionality of the adjacent lamination member models) is a state of an angle (directionality) of the adjacent lamination member models in the lamination direction. For example, if the directionality of the adjacent lamination member models is equal to or more than a predetermined angle (for example, 60°), the adjacent directionality is poor. If the adjacent directionality is poor, peeling is likely to occur on the interface. Accordingly, by performing the evaluation by using the adjacent directionality as an index, it is possible to evaluate whether or not the peeling is likely to occur on the interface. When performing the evaluation using the adjacent directionality, a higher score (penalty score) is applied, as the adjacent directionality becomes poor (as the angle of the adjacent laminated models increases), based on the angle of the adjacent lamination member models.

The continuous lamination properties (continuous lamination properties of lamination member models having the same directionality) are a continuous laminated state of lamination member models having the same directionality in the lamination direction. For example, if a predetermined number or more of lamination member models having the same directionality are continuously laminated, the continuous lamination properties are in a poor state. If the continuous lamination properties are poor, cracks are likely to occur. Accordingly, by performing the evaluation by using the continuous lamination properties as an index, it is possible to evaluate whether or not the cracks are likely to occur. When performing the evaluation using the continuous lamination properties, a higher score (penalty score) is applied, as the continuous lamination properties become poor (as the number of continuously lamination member models having the same directionality increases), based on the continuous laminated state of the lamination member models having the same directionality.

As described above, by performing the evaluation using the symmetry, the adjacent directionality, and the continuous lamination properties as indices, it is possible to evaluate whether or not the lamination order is such that warpage, peeling, and cracks are likely to occur.

That is, the penalty score for the symmetry, the penalty score for the adjacent directionality, and the penalty score for the continuous lamination properties are applied to each cell. In a case of evaluating the lamination pattern of the cell using a plurality of types of the indices, the evaluation unit 12 may evaluate the cell according to an evaluation norm based on each index. Specifically, for each cell, the norm of the penalty score (square root of the sum of the squares of each score) of each index is calculated, and the calculated norm is the evaluation of each cell. By performing the evaluation using the norm in each cell, it is possible to suppress that only a specific index has a strong influence on the evaluation, and to determine the evaluation of each index in a well-balanced manner as a whole.

In addition, the evaluation unit 12 calculates the evaluation of the individual model by taking the sum of the evaluations (scores calculated by the norm) of each cell. For example, in the example of FIG. 7, each of the 78 cells is evaluated using each index, and the evaluation of the cell is calculated based on the norm of the penalty score of each evaluation. The evaluation of the individual model is calculated by calculating the sum of the evaluations (norms) of each of the 78 cells. Since the penalty score is applied to each cell, a higher score is not preferable in the evaluation of the individual model.

The evaluation index of the evaluation unit 12 can also be set, in addition to the symmetry, the adjacent directionality, and the continuous lamination properties. For example, the directionality of the lamination member models laminated on the outermost side may be added as an evaluation index. The directionality of the lamination member models laminated on the outermost side refers to that, for example, a lamination member model having a predetermined angle (for example, a 90° layer) is laminated on the outermost layer. In this case, the penalty score is applied, if the directionality of the lamination member model laminated on the outermost layer does not show a predetermined angle.

The evaluation unit 12 evaluates each individual model of the generated group of individuals (for example, the initial generation) as described above, and evaluates all the individual models of the group of individuals. When the evaluation is performed for each individual model, the information related to the evaluation is output to the ranking unit 13.

The ranking unit 13 ranks each individual model of the group of individuals based on the evaluation of the evaluation unit 12. Specifically, since the evaluation unit 12 scores by the penalty score, each individual is ranked in ascending order of the penalty score. That is, the individual model at high ranking has a low penalty score and a more preferable lamination order is obtained for each evaluation index. That is, the higher the ranking of the individual model, the higher the fitness.

By performing the ranking as described above, it is possible to identify an individual model that matches to the evaluation index among the individual models in the generated group of individuals. That is, it is possible to express in a ranking that which lamination order of the lamination member models set based on the load condition is preferable for the evaluation index. Therefore, the genetic algorithm can be evolved so as to proceed the progress to match to the evaluation index more, and proceed the processing by the genetic algorithm efficiently.

The ranking information of each individual model is output to the next generation generating unit 14.

The next generation generating unit 14 selects an individual model from the group of individuals by selection based on the ranking, generates a new individual model by selecting at least any one of crossover, replication, and mutation, and updates the group of individuals as a next generation. That is, the next generation generating unit 14 changes the lamination order of the individual models and generates the next generation group of individuals so as to search for a more preferable lamination order.

In the next generation generating unit 14, the probability of occurrence is set in advance for each process of the crossover, replication, and mutation, and when the next generation is generated, the process to be executed based on the probability of occurrence is selected. In the present embodiment, the case of selecting any of the process of crossover, replication, and mutation is described, but a plurality of processes may be combined to generate a next generation individual. The probability of occurrence is set in advance by the user or the like. For example, the probabilities of occurrence of crossover, replication, and mutation are set as 65%, 30%, and 5%, respectively.

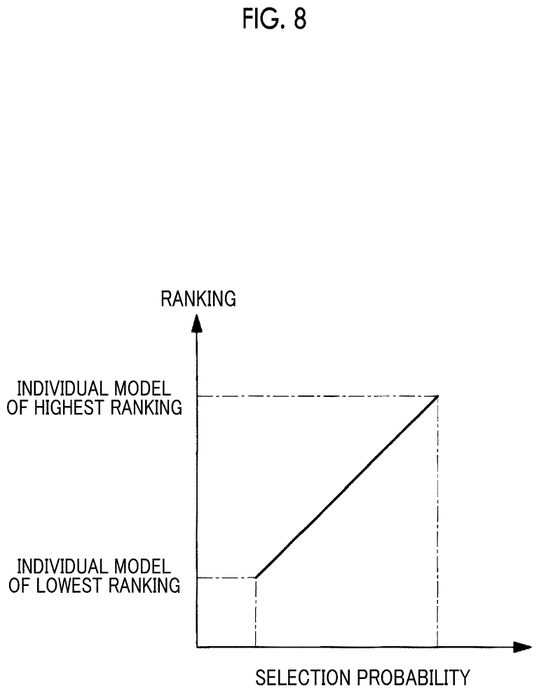

The next generation generating unit 14 selects an individual model from the generated group of individuals by the selection based on the ranking. The selection based on the ranking is a method in which the higher the ranking, the higher the selection probability is set, and accordingly, the higher the ranking, the easier it is to select an individual model. For example, as shown in FIG. 8, a selection probability is set so that the selection probability increases with a predetermined gradient, as the ranking increases (linear function). As long as the selection probability is higher as the ranking is higher, it is not limited to the case expressed by a linear function. By performing the selection based on the ranking, it is possible to perform process such as crossover on the individual model having a higher ranking, and accordingly, it is possible to proceed the progress in a direction of lowering the penalty score.

The next generation generating unit 14 selects the individual model by the selection based on the ranking according to the selected process (any one of crossover, replication, and mutation). Specifically, since it is necessary to use two individuals when performing the crossover, two individual models are selected from the group of individuals by the selection based on the ranking. When performing the replication or mutation, one individual model is selected from the group of individuals by the selection of the ranking.

The crossover is a sequential crossover or a partial mapping crossover. When performing the crossover, two individual models are used. However, since the laminated structure of each individual model is set so as to match to the load conditions, if the laminated structure changes due to crossover, the load resistance performance may be affected. Therefore, in the crossover, a crossover method that does not affect the preset laminated structure is used. That is, the type and number of lamination member models included in the individual model are not changed, and only the lamination order is changed.

Sequential crossover is a method for maintaining the position and the lamination order of a part of one individual model as they are, and rearranging for the remaining part of the lamination member model of the one individual model according to the lamination order of another individual model. In other words, the sequential crossover is a method for setting the lamination order as the same as a part of one individual and rearranging the lamination order of the remaining part based on the lamination order of another individual.

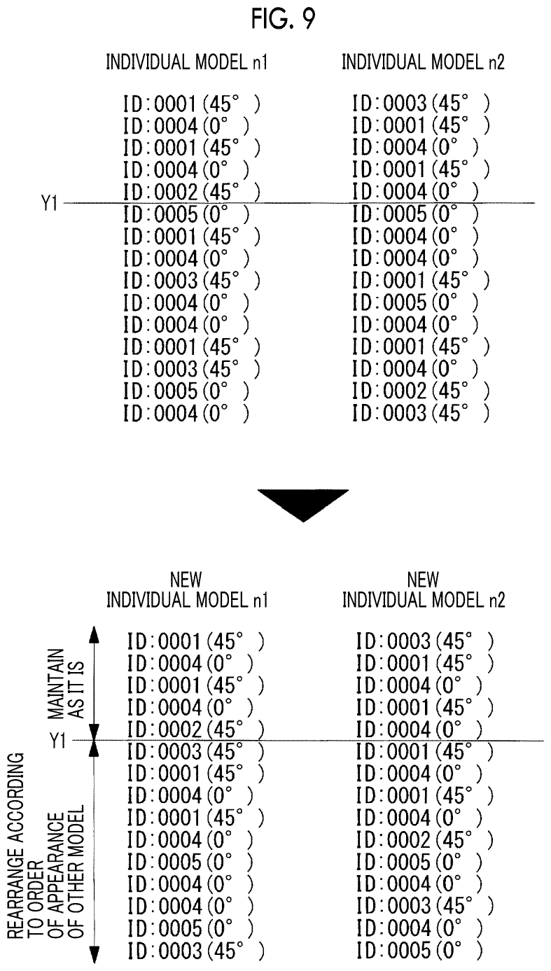

FIG. 9 is a diagram showing specific sequential crossover. FIG. 9 shows a case of performing the sequential crossover by using an individual model n1 and an individual model n2 of FIG. 6. As shown in FIG. 9, first, a cut line Y1 is randomly set. Then, a configuration (gene) above the cut line Y1 is maintained as is. Then, in the new individual model n1, each lamination member model below the cut line Y1 of the individual model n1 is rearranged according to the lamination order of the corresponding lamination member models in the other individual model n2. As described above, the new individual model n1 and the new individual model n2 are generated.

As described above, by performing the sequential crossover, only the lamination order can be changed without affecting the type and the number of lamination member models included in the individual before and after the crossover. Therefore, it is possible to execute the crossover while satisfying the load condition.

The partial mapping crossover is a method for determining two lamination member models to be rearranged based on the correspondence of the lamination order of the two individual models, and rearranging the two determined lamination member models in each individual model. In other words, the partial mapping crossover is a method for setting a rearranged pattern by associating the lamination member models at the same laminated position in the two individual models, and rearranging the lamination member models having the same characteristics as the lamination member model having the set rearranged pattern in each individual model.

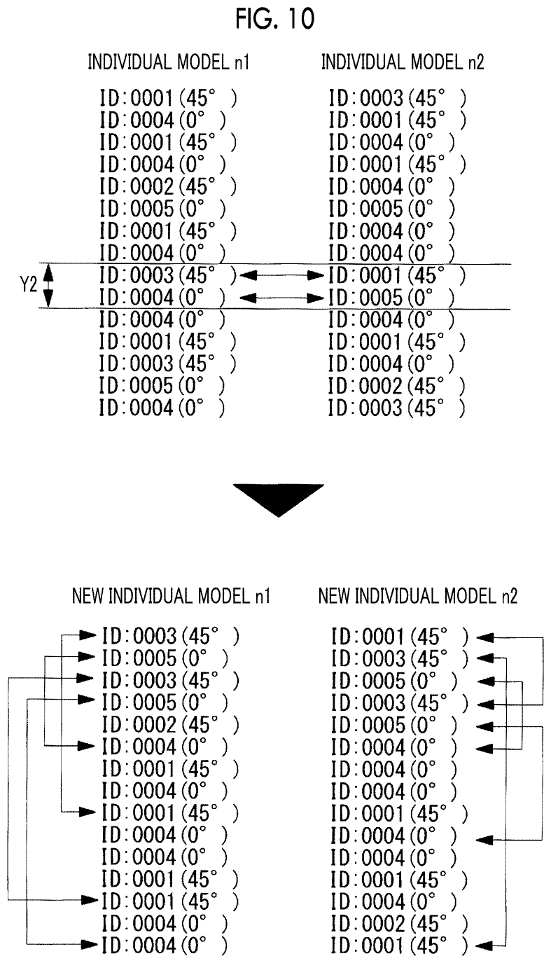

FIG. 10 is a diagram showing specific partial mapping crossover. FIG. 10 shows a case of performing the partial mapping crossover by using an individual model n1 and an individual model n2 of FIG. 6. As shown in FIG. 10, first, a crossover range Y2 is randomly set. A combination of the lamination member models facing each other (at the corresponding laminated position) in the crossover range Y2 is set as the rearranged pattern. In the example of FIG. 10, 0003 (45°) and 0001 (45°), and 0004 (0°) and 0005 (0°) are set as the rearranged patterns, respectively. Then, in each individual model, the rearrangement is performed according to the set rearranged pattern, and the new individual model n1 and the new individual model n2 are generated.

As described above, by performing the partial mapping crossover, only the lamination order can be changed without affecting the type and the number of lamination member models included in the individual model before and after the crossover. Therefore, it is possible to execute the crossover while satisfying the load condition.

Any crossover method can be applied without being limited to the above configuration, as long as it is a crossover method capable of changing only the lamination order, without affecting the laminated structure of each individual model.

The replication is a method for generating an individual model by copying the selected individual model as it is. That is, when the replication is selected, the individual models selected by the ranking selection are copied in the same lamination order to generate individuals, which are then included in the next generation group of individuals.

The mutation is a method for changing a part of the lamination order in the selected individual models. Specifically, the mutation may occur by selecting a section having a predetermined width in the lamination direction in a laminated state of the lamination member model in the selected individual model, and rearranging the lamination order of the lamination member models in the section. The predetermined width may be preset in a range of ¼ or less with respect to a total number of laminated layers of the lamination member models in the individual models. When the mutation occurs in a range of about ¼, it is possible to perform the rearrangement without significantly changing the lamination order.

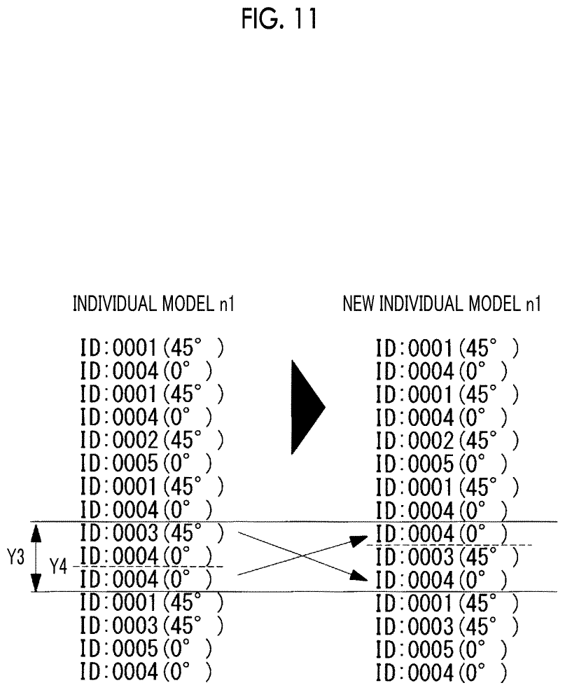

FIG. 11 is a diagram showing specific mutation. FIG. 11 shows a case of performing the mutation by using the individual model n1 of FIG. 6. As shown in FIG. 11, first, a section Y3 having a predetermined width is selected. In the example of FIG. 11, the total number of laminated layers is 15, and accordingly, a section is randomly selected with three layers for a predetermined width as a range of ¼ or less. Then, a cut line Y4 is set in the section Y3, and the lamination member models are exchanged with respect to the cut line Y4 in the section Y3. As described above, the new individual model n1 is generated.

The next generation generating unit 14 increases the probability of occurrence of mutation, when creating a group of individuals for a predetermined generation. For example, the next generation generating unit 14 increases the probability of occurrence of the mutation for certain generation. The mutation can significantly change the characteristics of the individual, and accordingly, the probability of occurrence is set low. In the present embodiment, the probability of occurrence of the mutation is set to 5%. However, if the lamination order of individuals is a local optimum solution, the probability for getting out of the local optimum solution and reaching the overall optimum solution is low in the crossover and the like. Therefore, by making it easier for mutation to occur intentionally under certain conditions, it is possible to increase the possibility of getting out of the local optimum solution by mutation. By doing so, it is possible to improve the possibility of reaching the overall optimum solution. In the present embodiment, for each certain generation, for example, the probability of occurrence of the mutation is increased to about 85% or more and less than 90%.

In the present embodiment, the group of individuals generated by the next generation generating unit 14 is evaluated and ranked until the generation of the group of individuals reaches a predetermined generation, and a new generation group of individuals is further generated in the next generation generating unit 14. That is, the group of individuals is processed until it reaches a predetermined generation, and the progress of the individual model proceeds. Since the progresses proceeds by selecting the ranking, the progress proceeds in a direction in which the penalty score of the predetermined evaluation index decreases.

The identification unit 15 identifies an individual model matching to the index based on the ranking. Specifically, when the generation of the group of individuals reaches a predetermined final generation, the identification unit 15 identifies an individual model having a lowest penalty score (individual model having the highest ranking) in each individual model of the final generation as a final individual model.

Since the final individual model is an individual model having the lowest penalty score, the lamination order is optimized. Therefore, by generating the composite material according to the lamination order of the final individual model, it is possible to suppress the occurrence of defects such as warpage.

It is not limited to a case where the final generation is reached, the identification unit 15 may identify the individual model as the final individual model, if the penalty score of the individual model is less than a predetermined score.

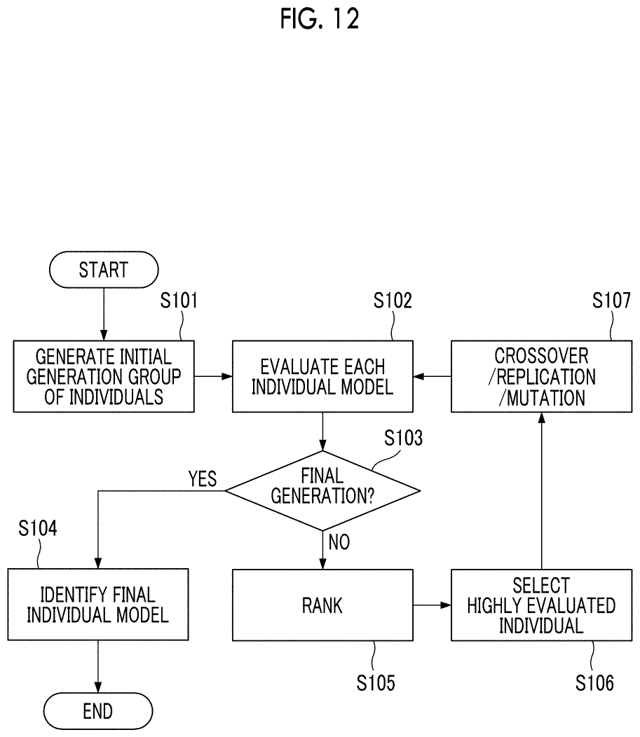

Next, a lamination order optimization process by the composite material design device 1 described above will be described with reference to FIG. 12. A flow shown in FIG. 12 is executed, when a process start command is input by a user or the like.

First, an initial generation group of individuals is generated (S101). Specifically, based on the load conditions, the type of the directionality, the shape, and number of lamination member models included in the composite material are set, and the lamination order of each lamination member model is randomly set to generate a predetermined number (for example, 100) individual models.

Next, each individual model is evaluated using a predetermined evaluation index (S102). The evaluation indices are the symmetry, the adjacent directionality, and the continuous lamination properties. The individual model is evaluated for each cell by these evaluation indices, and the evaluation for each cell is comprehensively evaluated to evaluate the individual model.

Next, it is determined whether or not the generated group of individuals is the final generation (S103). If the generated group of individuals is the final generation (determined as YES in S103), an individual model having a lowest penalty score (individual model having the highest ranking) in each individual model of the final generation is identified as a final individual model (S104). The final generation is set to, for example, 150 generations, with the initial generation as a first generation. The final generation can be suitably designed.

If the generated group of individuals is not the final generation (determined as NO in S103), the ranking is performed based on the evaluation of each individual model of the generated group of individuals (S105). Since the evaluation is performed by applying the penalty scores, the ranking is created by ranking in ascending order of score.

Next, the individual model to be processed is selected by selecting a highly evaluated individual (S106). By selecting the highly evaluated individual, it becomes easier to select an individual model (individual model having a high fitness) with a high ranking (high ranking), and accordingly, it is possible to proceed with progress in the direction of increasing fitness. In S106, in addition to or in place of selecting highly evaluated individuals, elite selection may be performed. In the elite selection, a predetermined number of individual models in the high ranking is selected. The elite-selected individual model is also subjected to processing such as crossover in S107 which will be described later, in the same manner as in the case of selecting a highly evaluated individual. By performing elite selection, it is possible to more reliably process individual models having high fitness.

Next, the selected individual model is subjected to at least one process of crossover, replication, and mutation to generate a new individual model (S107). The processing of S107 makes it possible to proceed the progress.

Then, when a new generation group of individuals is generated, the process returns to S102 and the above processes are repeatedly executed.

As described above, it is possible to apply the genetic algorithm to the design of the composite material and automatically identify a more appropriate lamination order. That is, by actually laminating the lamination members according to the lamination order of the final individual models identified by the above process, a lamination member having high compatibility with the evaluation index (symmetry, adjacent directionality, and continuous lamination properties) can be designed.

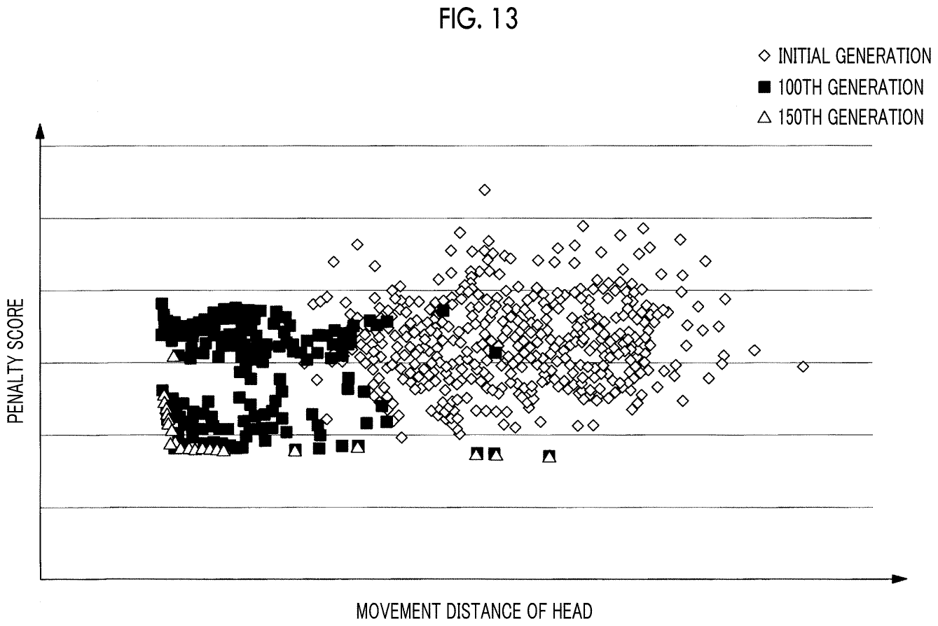

In the present embodiment, the case of single purpose (penalty score) has been described, but the same can be applied to multi-purpose optimization. In the case of multi-purpose optimization, for example, in addition to the applying of the above-mentioned penalty score, it is possible to perform the evaluation with at least one of a movement distance of a head of a laminating machine, the time required for laminating, and an amount of material to be used. In this case, the penalty score is calculated as described above, and the penalty score is calculated based on at least one of the movement distance of the head of the laminating machine, the time required for the laminating, and the amount of the material to be used, and the process may be performed in the same manner as the flow of FIG. 12 by using the norms of the both penalty scores (a total thereof may also be simply used) as a total penalty score. In addition, as the multi-purpose optimization, for example, a method of treating both indices in the same row (search for Pareto solution) may be used. As described above, the multi-purpose optimization can be performed by ranking between individuals based on a plurality of indices. An example of performing the multi-purpose optimization is shown in FIG. 13. FIG. 13 shows an example in which an evaluation relating to the movement distance of the head of the laminating machine is performed in addition to the penalty score. In the example of FIG. 13, the evaluation of each individual model in the initial generation, the 100th generation, and the 150th generation is plotted. As the progress proceeds, the penalty score decreases and the individual model is generated in a direction in which the movement distance of the head decreases. Therefore, it is possible to identify an individual model optimized for multiple purposes.

As described above, according to the composite material design device, the composite material design method, and the composite material design program according to the present embodiment, the individual model in which the lamination member models are laminated is divided into predetermined cells, and the lamination pattern of each cell is evaluated by using at least any one index of a symmetry regarding the lamination of the lamination member models, a directionality of the adjacent lamination member models, and continuous lamination properties of the lamination member models having the same directionality, and accordingly, the evaluation can be performed for each cell. For each cell, it is possible to evaluate whether or not the symmetry regarding the lamination of the lamination member model, the directionality of the adjacent lamination member models, and the continuous lamination properties of the lamination member models having the same directionality are preferable, and thus the individual model can be evaluated in detail. Since the symmetry regarding the lamination of the lamination member model is used as the index of the evaluation, it is possible to evaluate whether or not warpage is likely to occur in an actual manufacturing process. Since the directionality of the adjacent lamination member models is used as the index of the evaluation, it is possible to evaluate whether or not peeling is likely to occur at an interface. Since the continuous lamination properties of the lamination member models having the same directionality are used as the index of the evaluation, it is possible to evaluate whether or not cracks are likely to occur.

In addition, since the ranking is performed based on the evaluation and the highly evaluated individual is selected, it is possible to generate a new individual model using an individual model more matching to the index of the evaluation (generate a next generation group of individuals), and proceed progress so as to more match to the index of the evaluation. Since the individual model is identified based on the ranking, it is possible to identify a more optimal lamination pattern of the lamination members. That is, it is possible to automatically identify a more appropriate lamination pattern of the lamination members based on the index, reduce the burden of human resource, and design a composite material with an appropriate lamination pattern of the lamination member.

In a case of using the plurality of types of indices in the evaluation, the evaluation norm based on each index is obtained, and accordingly, the evaluation of each index can be balanced. That is, it is possible to suppress that only a specific index has a strong influence on the evaluation, and to determine the evaluation of each index in a well-balanced manner as a whole.

By using the sequential crossover or the partial mapping crossover, it is possible to perform the crossover without affecting a configuration of each lamination member model having directionality designed based on the load condition (configuration regarding the number of lamination members having a certain directionality included) at the time of creating the initial generation. Therefore, it is possible to design the lamination pattern of the lamination member models so as to more reliably satisfy the load condition.

Since the mutation may occur by rearranging the lamination order in the selected section having the predetermined width in the lamination direction in the laminated state of the lamination member model in the individual model, it is possible to occur mutation without affecting the configuration of each lamination member model having a directionality designed based on load condition (configuration regarding the number of lamination members having a certain directionality included) at the time of creating the initial generation. Therefore, it is possible to design the lamination pattern of the lamination member models so as to more reliably satisfy the load condition.

In a case of creating the group of individuals for the predetermined generation, by increasing the probability of occurrence of mutation, the mutation is likely to occur and it is possible to suppress maintenance of the local optimum solution.

The present invention is not limited to the embodiments described above, and can be appropriately modified within a range not departing from the gist of the present invention.

### REFERENCE SIGNS LIST

1: Composite material design device
11: Initial generation generating unit
12: Evaluation unit
13: Ranking unit
14: Next generation generating unit
15: Identification unit

1. A composite material design device using a genetic algorithm, the device comprising:
an initial generation generating unit that generates, as an initial generation group of individuals, a plurality of individual models by laminating each lamination member model having a directionality of strength designed based on a load condition in plurality of orders;
an evaluation unit that divides each individual model in the generated group of individuals into predetermined cells, and evaluates a lamination pattern of each cell by using at least any one index of a symmetry regarding the lamination of the lamination member models, a directionality of adjacent lamination member models, and continuous lamination properties of the lamination member models having the same directionality;
a ranking unit that ranks each individual model of the group of individuals based on the evaluation of the evaluation unit;
a next generation generating unit that selects an individual model having a high evaluation value from the group of individuals based on the ranking, generates a new individual model by selecting at least any one of crossover, replication, and mutation, and updates the group of individuals as a next generation; and
an identification unit that identifies the individual model having the high evaluation value based on the ranking.

2. The composite material design device using a genetic algorithm according to claim 1,
wherein the evaluation unit evaluates each cell in the individual model using the index, and integrates the evaluation of each cell in the individual model to perform evaluation of the individual models.

3. The composite material design device using a genetic algorithm according to claim 1,
wherein, in a case of evaluating the lamination pattern of the cell using a plurality of types of the indices, the evaluation unit evaluates the cell according to an evaluation norm based on each index.

4. The composite material design device using a genetic algorithm according to claim 1,
wherein the crossover is a sequential crossover or a partial mapping crossover.

5. The composite material design device using a genetic algorithm according to claim 1,
wherein the mutation occurs by selecting a section having a predetermined width in a lamination direction in a laminated state of the lamination member model in the selected individual model, and rearranging a lamination order of the lamination member models in the section.

6. The composite material design device using a genetic algorithm according to claim 5,
wherein the predetermined width is preset in a range of ¼ or less with respect to a total number of laminated layers of the lamination member models in the individual models.

7. The composite material design device using a genetic algorithm according to claim 1,
wherein the next generation generating unit selects at least any one processing of the crossover, the replication, and the mutation based on a preset probability of occurrence for each process, and increases the probability of occurrence regarding the mutation, in a case of creating the group of individuals for a predetermined generation.

8. The composite material design device using a genetic algorithm according to claim 1,
wherein the evaluation unit performs evaluation based on the index and the directionality of the lamination member model laminated on an outermost side.

9. A composite material design method using a genetic algorithm, the method comprising:
an initial generation generating step of generating, as an initial generation group of individuals, a plurality of individual models by laminating each lamination member model having a directionality of strength designed based on a load condition in plurality of orders;
an evaluation step of dividing each individual model in the generated group of individuals into predetermined cells, and evaluating a lamination pattern of each cell by using at least any one index of a symmetry regarding the lamination of the lamination member models, a directionality of adjacent lamination member models, and continuous lamination properties of the lamination member models having the same directionality;
a ranking step of ranking each individual model of the group of individuals based on the evaluation of the evaluation step;
a next generation generating step of selecting an individual model having a high evaluation value from the group of individuals based on the ranking, generating a new individual model by selecting at least any one of crossover, replication, and mutation, and updating the group of individuals as a next generation; and
an identification step of identifying the individual model having the high evaluation value based on the ranking.

10. A composite material design program using a genetic algorithm for causing a computer to execute:
an initial generation generating process of generating, as an initial generation group of individuals, a plurality of individual models by laminating each lamination member model having a directionality of strength designed based on a load condition in plurality of orders;
an evaluation process of dividing each individual model in the generated group of individuals into predetermined cells, and evaluating a lamination pattern of each cell by using at least any one index of a symmetry regarding the lamination of the lamination member models, a directionality of adjacent lamination member models, and continuous lamination properties of the lamination member models having the same directionality;
a ranking process of ranking each individual model of the group of individuals based on the evaluation of the evaluation process;
a next generation generating process of selecting an individual model having a high evaluation value from the group of individuals based on the ranking, generating a new individual model by selecting at least any one of crossover, replication, and mutation, and updating the group of individuals as a next generation; and
an identification process of identifying the individual model having the high evaluation value based on the ranking.
